(19) United States
(12) Patent Application Publication
(10) Pub. No.: US 2011/0069179 A1
(43) Pub. Date: Mar. 24, 2011

(54) NETWORK COORDINATED EVENT CAPTURE AND IMAGE STORAGE

(75) Inventors: Steven N. Bathiche, Kirkland, WA (US); Miller T. Abel, Mercer Island, WA (US); James E. Allard, Seattle, WA (US)

(73) Assignee: MICROSOFT CORPORATION, Redmond, WA (US)

(21) Appl. No.: 12/566,058

(22) Filed: Sep. 24, 2009

(51) Int. Cl. H04N 5/225

(52) U.S. Cl. 348/207.1; 348/E05.024

(57) ABSTRACT

A system and method are disclosed for coordinating different image capture devices at an event so that images captured by the different devices may form a cohesive and consistent image set. The system includes a group of image capture devices, referred to herein as an event capture group, wirelessly communicating with a remote server. The image capture devices in an event capture group may consist of still image cameras, video recorders, mobile phones and other devices capable of capturing images. The server coordinates the devices in a group before images are taken, so that the resultant images from the different devices are consistent with each other and may be aggregated into a single, cohesive image set. Images from different devices in the group may be uploaded during an event and organized on a remote database into the image set which may be viewed during or after the event.

### BACKGROUND

Great strides have been made recently in the ability to easily create and share images such as photographs and video. Consumers now have the ability to create digital images using a wide range of digital imaging and recording devices, including still photo cameras, video recorders, mobile telephones and web cameras. Several so-called cloud storage companies now exist which provide secure image storage on remote servers via the Internet. These sites offer the ability to remotely aggregate, organize, edit, publish and share stored media images. Such cloud storage sites include Shutterfly.com, Snapfish.com, Flickr.com to name a few.

Until recently, captured digital images needed to be downloaded from a camera or video recorder onto a user's computer. From there, the user could then share the media by email, or upload the media to a cloud storage site or other centralized server. Recently, some cameras have been developed having a wireless network connection so that once a still or video image is captured, it can be directly shared and/or uploaded to a central storage location. An example of such a camera is the Cyber-shot DSC-G3 digital still camera by Sony Corp., Tokyo, Japan.

Despite the strides in the ability to share digital images, little has been done with regard to networking and communication of recording devices pre-capture; that is, before digital images have been created and stored. Cameras are ubiquitous at events such as weddings, birthdays and other events, and the sharing of captured images after these events is commonplace. People frequently like collecting the images of others, so that they can see portions of the event that they may have missed. However, as there is little or no pre-capture coordination, images captured from different devices typically do not fit together in a cohesive image narrative of the event. For example, images from different devices may have color balance or exposure shifts. Thus, if images from different devices are put together, for example in a slide show or panorama, the images appear disjointed and inconsistent.

One reason for this is that cameras and other image capture devices have a wide variety of features for controlling device parameters to ensure that the captured image is clear, sharp and well-illuminated. These parameters include:
F-Stop—F-stop is the setting of the iris aperture to control the amount of light passing through the lens. The F-stop setting also has an effect on focus and depth of field. The smaller the opening aperture, the less light but the greater the depth of field (i.e., the greater the range within which objects appear to be sharply focused).
Shutter speed—shutter speed is the speed setting of the shutter to control the amount of time the imaging medium is exposed to light.
White balance—white balance is an electronic compensation of the color temperature of a captured image so that the colors in an image appear normal. Color temperature is the relative warmth or coolness of the white light in an image.
ISO sensitivity—ISO sensitivity is the film speed, which controls the device's sensitivity to light in captured images. In digital image recording devices, ISO sensitivity refers to an indication of the system's gain from light to numerical output and to control the automatic exposure system.
Auto-focus—autofocus is the moving of the capture lens elements towards or away from the imaging medium until the sharpest image of the desired subject is projected onto the imaging medium. Depending on the distance of the subject from the camera, the lens elements must be a certain distance from the focal plane to form a clear image.

While many cameras today have automatic settings which control some or all of these features, the automatic settings between different cameras are not calibrated with respect to each other. Thus, different devices may capture the same subject at the same time, but one or more of the camera parameters will be different between the devices. This will result in the images from the different devices having different properties (e.g., white balance, exposure, brightness, etc.).

A further consequence of the lack of pre-capture coordination is that a given subject at the event may be over-photographed by the different cameras, while another subject may be under-photographed. Similarly, a given subject may be over-photographed from a particular angle by the different cameras, while not enough images are taken from another angle.

An event may also include visiting a natural or manmade attraction, such as for example Yosemite National Park or the Space Needle in Seattle to name two. The person capturing a subject or subjects at these events may not be familiar with a subject being photographed. As such, there may be optimal locations/perspectives from which to capture the subject, or there may be optimal camera settings to use for best capturing the subject, but the person may not be aware of these.

### SUMMARY

Embodiments of the present system in general relate to a method for coordinating different image capture devices at an event so that images captured by the different devices may form a cohesive and consistent image set. In general, an embodiment consists of a group of image capture devices, referred to herein as an event capture group, wirelessly communicating with a remote server. The image capture devices in an event capture group may consist of still image cameras, video recorders, mobile phones and other devices capable of capturing images. The server coordinates the devices in a group before images are taken, so that the resultant images from the different devices are consistent with each other.

In a first aspect of the present system, the server groups two or more image capture devices at an event into the event capture group. The grouping may be done based on two or more image capture devices being sensed in the same location for a predetermined period of time. The server is able to make this determination based on GPS transmitters in the image capture devices. Once a group is formed, the group can continuously or periodically relay metadata to the server about which settings the different image capture devices at the event are set to, as well as conditions at the event.

In a second aspect of the present system, the server interprets the metadata received and provides feedback to the image capture devices in the event capture group relating to optimal settings to use when capturing images at the event. These optimal settings are provided to ensure the devices capture consistent and cohesive images with each other. The server may apply one or more policies governing how the server is to interpret the metadata to arrive at recommended optimal device settings for the devices at the event.

In a third aspect of the present system, the server and image capture devices of the event capture group may focus on capturing a specific subject at the event. The server may supply the image capture devices with optimal settings, as discussed above. Additionally, in certain instances, the server is also able to choreograph the positioning of different image capture devices in order to capture the best positions and perspectives of the specific subject.

In a fourth aspect of the present system, images may be uploaded, organized and stored in a remote database in a cohesive image set, even before an event has ended. The pre-capture feedback provided by the server allows the different images from different devices at an event to be captured and aggregated together into a single image set which has a cohesive and consistent appearance.

### BRIEF DESCRIPTION OF THE DRAWINGS

FIG. 1 is an illustration of a system for coordinating different image capture devices at an event.

FIG. 2 is a block diagram of an exemplary image capture device.

FIGS. 3 and 3A show a flowchart for forming event capture groups.

FIGS. 4 through 4B show a flowchart for providing general event image capture feedback.

FIGS. 5A and 5B show a flowchart for providing image capture feedback for capturing a specific subject at an event.

FIGS. 6 and 6A show a flowchart for uploading and organizing images captured at an event.

FIG. 7 is a block diagram of components of a computing environment for executing aspects of the present system.

### DETAILED DESCRIPTION

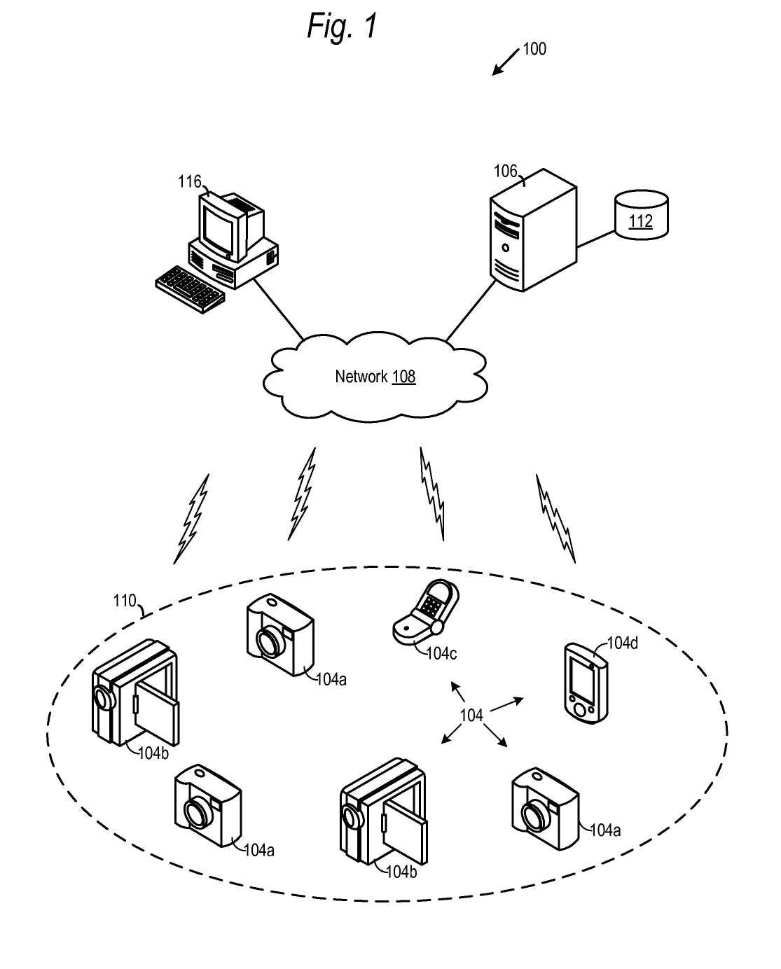

Embodiments of the present system will now be described with reference to FIGS. 1-7, which in general relate to a method for coordinating different image capture devices at an event so that images captured by the different devices may form a cohesive and consistent image set. Referring initially to FIG. 1, there is shown a system 100 including a plurality of image capture devices 104 connected to a remote server 106 via a network 108. The image capture devices 104 may include one or more still image cameras 104a, video recorders 104b, mobile telephones 104c having image capture capabilities and/or personal digital assistants (PDAs) 104d having image capture capabilities. Other known image capture devices may also be included in system 100 in addition to or instead of the devices 104 shown in FIG. 1.

Two or more image capture devices 104 which are present at an event may be grouped together into an event capture group 110. As explained below, capture devices 104 in an event capture group 110 act in concert and coordinate/are coordinated with each other pre-image capture under the control of server 106 to capture images at an event. In embodiments, the image capture devices 104 within an event capture group 110 provide metadata regarding an event to the remote server 106 via network 108. The server 106 in turn provides feedback to devices in the event capture group 110 to coordinate the capture of images at the event to provide a cohesive image set of the event taken from multiple image capture devices 104.

As used herein, the term “event” may refer to any setting where two or more image capture devices are present and capture images of a subject or subjects at the event. An event may be a social or recreational occasion such as a wedding, party, vacation, concert, sporting event, etc., where people gather together at the same place and same time and take photos and videos. An event may also be a location where people gather to photograph and/or video subjects, such as natural and manmade attractions. Examples include monuments, parks, museums, zoos, etc. Other events are contemplated.

The number and type of image capture devices 104 shown in event capture group 110 in FIG. 1 is by way of example only. The number of cameras 104a may be more or less than shown; the number of video cameras 104b may be more or less than shown; the number of mobile phones 104c may be more or less than shown; and the number of PDAs 104d may be more or less than shown. Event capture groups 110 may be formed and disbanded dynamically. As an example, a camera 104a may be part of a first event capture group at a first event. After the event is over, that event capture group may disband. The camera 104a may thereafter be present at a second event and form part of a second event capture group, which may disband when the second event is over, and so on. Membership within a given event capture group at an event may grow and shrink dynamically over the course of the event as explained below. As events occur all the time, there may be many different and independent event capture groups which exist simultaneously.

Image capture devices 104 may connect to each other and/or network 108 via any of various wireless protocols, including a WiFi LAN according to the IEEE 802.11 set of specifications, which are incorporated by reference herein in their entirety. Other wireless protocols by which image capture devices 104 may connect to each other and/or network 108 include but are not limited to the Bluetooth wireless protocol, radio frequency (RF), infrared (IR), IrDA from the Infrared Data Association, Near Field Communication (NFC), and home RF technologies. Where an event capture group 110 includes a mobile telephone 104c, a wireless telephone network may be used at least in part to allow wireless communication between the image capture devices 104 and the network 108.

In a further embodiment, instead of or in addition to a wireless connection, the image capture devices 104 may have a physical connection to network 108, for example via a USB (or other bus interface) docking station. While embodiments of the present system make advantageous use of a wireless connection so as to allow the real time exchange of data and metadata between each other and/or with server 106, it is understood that aspects of the present system may be carried out by an image capture device 104 which lacks a wireless connection. Such devices may exchange data and metadata with each other or with server 106 before, during or after an event upon connection to a docking station or other wired connection to network 108.

Images taken by devices 104 in an event capture group may be uploaded and saved together into an event image set. The event image set may be saved in a database 112. As shown in FIG. 1, the database 112 may be associated with server 106. However, the database 112 for storing images may be separate and independent from server 106 in further embodiments. In embodiments, one or both of the server 106 and the database 112 may be associated with a third party cloud storage website.

Each event image set may be stored with an identifier (such as an event name) by which an event image set may be identified and accessed after an event is over (or during the event). As is further explained below, images captured at an event may be subdivided to form more than one event image set, each stored with, and accessible by, its own identifier.

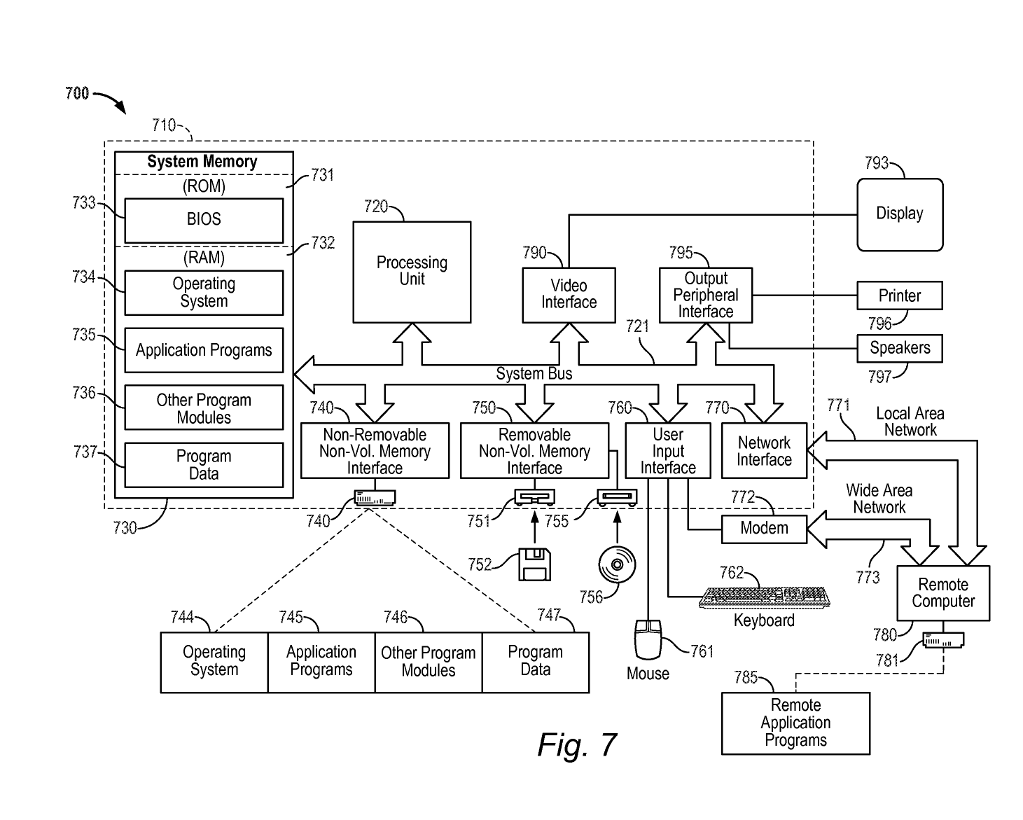

FIG. 1 further shows a computing device 116. Computing device 116 may be a home PC, laptop or a variety of other computing devices and is used to communicate with server 106 and/or database 112 before, during or after an event. As explained below, computing device 116 may communicate with server 106 to set up an event capture group in advance of an upcoming event. Computing device 116 may also be used to view images from image sets stored in database 112. Further details relating to one example of computing device 116 and/or server 106 are provided below with respect to FIG. 7.

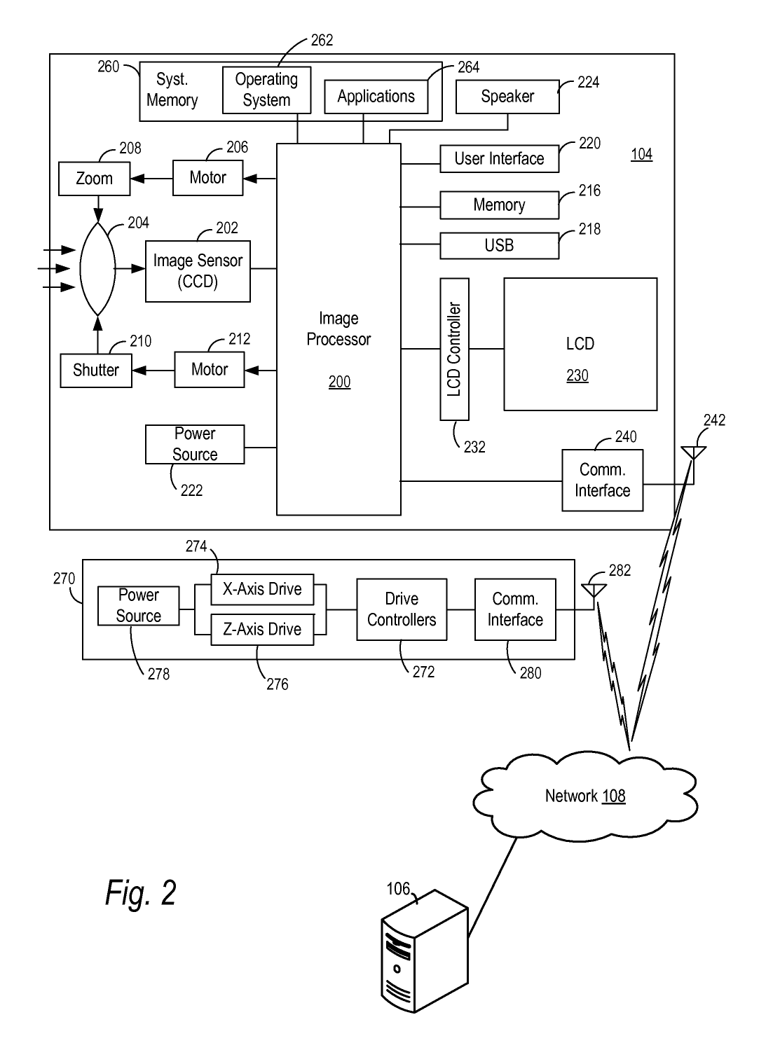

Details relating to an embodiment of an image capture device 104 for use with the present system will now be explained with reference to the block diagram of FIG. 2. FIG. 2 shows an embodiment where image capture device 104 is a digital camera. The block diagram of FIG. 2 is a simplified block diagram of components within the camera 104a, and it is understood that a variety of other components found within conventional digital cameras may be provided in addition to or instead of some of the components shown within camera 104a in alternative embodiments.

In general, digital camera 104a may include an image processor 200 which receives image data from an image sensor 202. Image sensor 202 captures an image through a lens 204. Image sensor 202 may be a charge coupled device (CCD) capable of converting light into an electric charge. Other devices, including complementary metal oxide semiconductor (CMOS) sensors, may be used for capturing information relating to an image. An analog-to-digital converter (not shown) may be employed to convert the data collected by the sensor 202. The zoom for the image is controlled by a motor 206 and zoom 208 in a known manner upon receipt of a signal from the processor 200. The image may be captured by the image sensor upon actuation of the shutter 210 via a motor 212 in a known manner upon receipt of a signal from the processor 200.

Images captured by the image sensor 202 may be stored by the image processor 200 in memory 216. A variety of digital memory formats are known for this purpose. In one embodiment, memory 216 may be a removable flash memory card, such as those manufactured by SanDisk Corporation of Milpitas, Calif. Formats for memory 216 include, but are not limited to: built-in memory, Smart Media cards, Compact Flash cards, Memory Sticks, floppy disks, hard disks, and writeable CDs and DVDs.

A USB connection 218 may be provided for allowing connection of the camera 104a to another device, such as for example computer 116. It is understood that other types of connections may be provided, including serial, parallel, SCSI and IEEE 1394 (“Firewire”) connections. The connection 218 allows transfer of digital information between the memory 216 and another device. The digital information may be digital photographs, video images, or software such as application programs, application program interfaces, updates, patches, etc. As explained above and in more detail below, camera 104a may further include a wireless communications interface.

A user interface 220 of known design may also be provided on camera 104a. The user interface may include various buttons, dials, switches, etc. for controlling camera features and operation. The user interface may include a zoom button or dial for affecting a zoom of lens 204 via the image processor 200. The user interface 220 may further include mechanisms for setting camera parameters (i.e., F-stop, aperture speed, ISO, etc.) and for selecting a mode of operation of the camera 104a (i.e., stored picture review mode, picture taking mode, video mode, autofocus, manual focus, flash or no flash, etc.). The user interface 220 may further include audio functionality via a speaker 224 connected to processor 200. As explained below, the speaker 224 may be used to provide audio feedback to a user regarding the pre-capture coordination of images at an event. The feedback may alternatively or additionally be provided over an LCD screen 230, described below.

The image captured by the image sensor 202 may be forwarded by the image processor 200 to LCD 230 provided on the camera 104a via an LCD controller interface 232. LCD 230 and LCD controller interface 232 are known in the art. The LCD controller interface 232 may be part of processor 200 in embodiments.

As indicated above, image capture device 104 may be part of a wireless network. Accordingly, the camera 104a further includes a communications interface 240 for wireless transmission of signals between camera 104a and network 108. Communications interface 240 sends and receives transmissions via an antenna 242. A power source 222 may also be provided, such as a rechargeable battery as is known in the art.

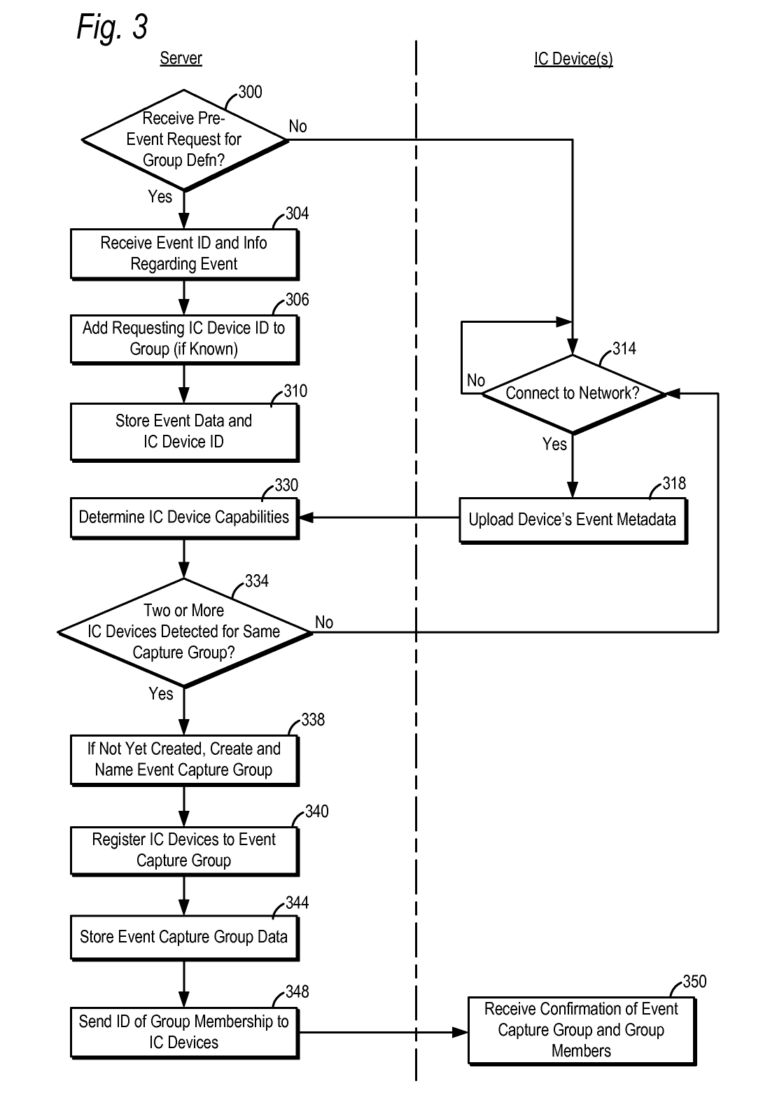

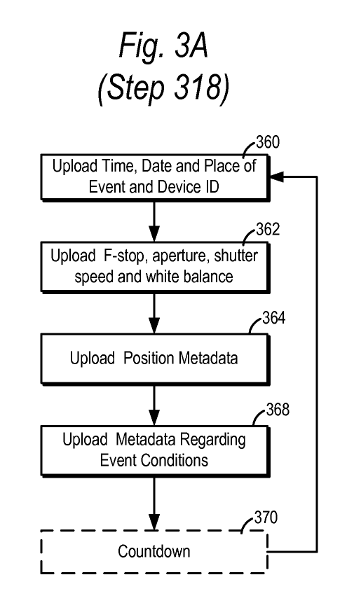

The image capture device 104 may further include a system memory (ROM/RAM) 260 including an operating system 262 for managing the operation of device 104 and applications 264 stored in the system memory. One such application stored in system memory is a client application according to the present system. As explained below, the client application controls the transmission of data (images) and metadata from the image capture device 104 to the server 106. The client application also receives feedback from the server 106 which may be implemented by the processor, or relayed to a user of the capture device 104 via audio and/or visual playback by speaker 224 and LCD 230. These features are explained below with reference to the flowcharts of FIGS. 3 through 6A.

It is understood that not all of the conventional components necessary or optionally included for conventional operation of camera 104a are described above. Other components, known in the art, may additionally or alternatively be included in camera 104a.

As explained below, in embodiments, an image capture device 104 may automatically implement feedback received from the server 106. This may include automatic repositioning of an image capture device 104 in embodiments where the image capture device is mounted on a tripod. In embodiments, such repositioning may include tilting the camera up or down (e.g., around an X-axis), panning the camera left or right (e.g., around a Z-axis), or a combination of the two motions. While a variety of configurations are known for automated repositioning of an image capture device around the X- and/or Z-axis, one example is further shown in FIG. 2.

A tripod (not shown) may include an actuation table 270 to which the image capture device 104 is attached. Actuation table 270 includes a communications interface 280 and an associated antenna 282 for receiving commands from the server 206 (either directly or routed through the image capture device 104 attached to the actuation table 270). Transmissions received in communications interface 280 are forwarded to drive controller(s) 272 which control the operation of the X-axis drive 274 and Z-axis drive 276 in a known manner. With this configuration, the actuation table 270 can reposition the image capture device 104 up/down and left/right based on feedback from the server 106.

Actuation table 270 may further include a power source 278, such as a rechargeable battery as is known in the art. Alternatively, the actuation table 270 may be electrically coupled to camera 104a when the camera and actuation table are affixed together. In such embodiments, the actuation table power source 278 may be omitted, and the actuation table instead receive power from the camera power source 222. It is understood that actuation table 270 may be omitted in alternative embodiments.

Event Capture Group Definition

The definition of event capture groups will now be described with reference to the flowcharts of FIGS. 3 and 3A. In general, event capture groups may be defined using two or more image capture devices detected at an event. However, an individual may set up an event capture group in advance of an event via computer 116 or other computing device. The pre-event request could also conceivably be made from an image capture device 104. The server 106 may receive such a request to set up a group in step 300. If so, the server receives a user-defined name to define the event capture group in step 304, as well as other information regarding the event such as time, place, size of gathering at event, etc.

In an embodiment, the user may also upload anticipated settings to be used by image capture devices at the event. As explained below, actual device settings will be uploaded by devices at the event. However, this pre-event estimation of settings can be used by the server 106 to provide pre-event feedback to image capture devices regarding optimal settings for devices that will not be able to connect to the network at the event.

In step 306, the server may obtain an identifier for the user's image capture device 104 that will be used at the event. Such an identifier may for example be a model of the image capture device and a serial number of the capture device. Other identifiers are contemplated, such as the device user's name, to uniquely identify different image capture devices. If the request to set up an event capture group is made from an image capture device 104, the server may automatically detect the identifier for the capture device. Step 306 may be skipped if the identifier is not known and is not detectable. The event data obtained in steps 304 and 306 may be stored on server 106, database 112 or elsewhere in step 310.

If no pre-event request to set up an event capture group is received, the system waits for an image capture device to detect and connect with the network in step 314. If a connection is established, an image capture device 104 may then upload metadata to the server 106 in step 318. In general, the image capture devices may upload image data (explained below), and data about an image or event where the image was captured. This later information may be referred to as metadata. There are in general two types of metadata. Explicit metadata refers to metadata captured or determined automatically by the image capture device. Examples of explicit metadata include, but are not limited to:
F-stop, aperture, shutter speed, white balance setting of an image capture device;
time code and date then registered by an image capture device;
file name of a captured image;
image capture device identifier—as explained above, this may be the make and model of an image capture device;
GPS and camera orientation—if a camera is equipped with the appropriate transmitters allowing detection of GPS position and sensors for allowing detection of camera orientation (sensed for example with a magnetic compass within the device), this may also be explicit metadata determined by an image capture device;
the current color calibration profile or other calibration settings in use by the camera to compensate for abnormalities in the image sensor or processing software, or for creative purposes, and/or the assumed color working space for prepared RGB images.

A second type of metadata is referred to as implicit metadata. This is data which is added by a user, or otherwise determined using means external to the image capture device. Examples of implicit metadata include, but are not limited to:
event name;
caption/comments added by a user to an image;
tagging people's name to their appearance in an image;
autotagging people's names to their appearance in an image;
autotagging known objects such as paintings, statues, buildings, monuments, landmarks, etc.;
keywords to allow query searching of captured images;
recommendation rating—rating an image in comparison to other images.

Referring again to step 318, an image capture device 104 may upload metadata relating to an event once the device is connected to a network. Referring now to FIG. 3A, step 318 may include the step 360 of uploading the time, date and place of an event and the device identifier. The client application of the present system may obtain this information from system memory 260 and direct the processor 200 to send it to the server 106 via communications interface 240 and antenna 242.

Many digital SLR cameras include a “live view” mode, where the device processor continuously synthesizes images that appear in the lens, even when not taking a photograph or recording video. This metadata, along with device setting metadata which remains fixed between image captures, may be uploaded to the server for a given image capture device 104 in step 362. The uploaded metadata may include one or more of the F-stop, aperture, shutter speed, white balance, ISO sensitivity, whether a flash is active, zoom magnification and other parameters of the device at the time the device registers with the network. For image capture devices having the appropriate transmitters/sensors, position metadata (GPS and orientation) may further be uploaded in step 364. In addition, metadata regarding conditions at the event may be uploaded in step 368. Such conditions may include for example measured light (which can affect whether a flash is needed for image capture).

Other metadata, implicit and explicit, may be uploaded to the server 106 in step 318 upon an image capture device initially connecting to the network. After the initial upload of metadata in step 318, step 318 may then be repeated continuously between the capture of images. Alternatively, the upload of metadata between the capture of images in step 318 may be performed periodically, for example after expiration of each countdown period of a predetermined length in step 370.

Referring again to FIG. 3, after the initial upload of metadata in step 318, the server 106 may determine the device capabilities in step 330. The server 106 may include a user agent as is known in the art for detecting the image capture device capabilities, including the type of device and features of the device.

In step 334, the server 106 may then detect whether two or more image capture devices are present at an event which can be added to the same event capture group 110. An event capture group 110 may be formed by a variety of methods. In one embodiment, image capture devices may be added to a given event capture group if two or more image capture devices are located within the same geographic space at the same time.

In particular, the server 106 applies a policy programmed into the server which looks for image capture devices 104 remaining within a given geographic space, such as a circle of a given radius, for at least a predetermined period of time. In other embodiments, the geographic space may be other shapes, and a given device may wander outside of the geographic space during some portion of the predetermined period of time. In further embodiments, there may not be a defined space, but rather respective devices will be added to an event capture group 110 if they remain within a given distance of each other (even if both are moving) for a predetermined period of time. The location of image capture devices as determined by a GPS system may be uploaded as metadata in step 318.

If two or more image capture devices 104 reside within a given geographic area for a predetermined period of time, the present system assumes their proximity is not coincidental, and the system may add them to an event capture group. However, in embodiments, before adding an image capture device 104 to an event capture group, the server 106 may query an image capture device connected to a network whether the user wants to join an event capture group the device qualifies for.

If two devices are not detected in order to create an event capture group in step 334, the system may return to step 314 to check for new image capture devices connected to the network. If two or more devices are detected in the same geographic and temporal vicinity, an event capture group may be created and named in step 338. The detected image capture devices may be registered within the group in step 340, and the event capture group data including name of the group, time and place of the event, and group membership, may be stored in step 344.

In an alternative embodiment, an event capture group 110 may be formed when two or more image capture devices 104 at an event can wirelessly communicate with each other. The devices that are able to connect wirelessly may be added to an event capture group 110, and this information uploaded to the server 106.

In step 348, the server 106 may send a message to each member of the event capture group 110 alerting them as to the creation of the group and letting each device know of the other members in the group. In step 350, members in the group may receive confirmation of the group and group membership. Users of image capture devices 104 in the group 110 may also be given the option at this point to opt out of the group. Alternatively, the client application on image capture devices may give members an option to opt out of a group at any time.

If an image capture device 104 leaves the geographic area defining the boundary of an event capture group 110 for a predetermined period of time, that device may be automatically dropped from the group. New devices 104 may be added to an event capture group 110 as the devices connect to the network in step 314 and are detected within range of the event capture group 110 in step 334. Membership may be updated in step 340 and communicated to members in step 348. It will be appreciated that an event capture group 110 may be created by steps other than or in addition to those set forth in FIGS. 3 and 3A.

General Event Image Capture Feedback

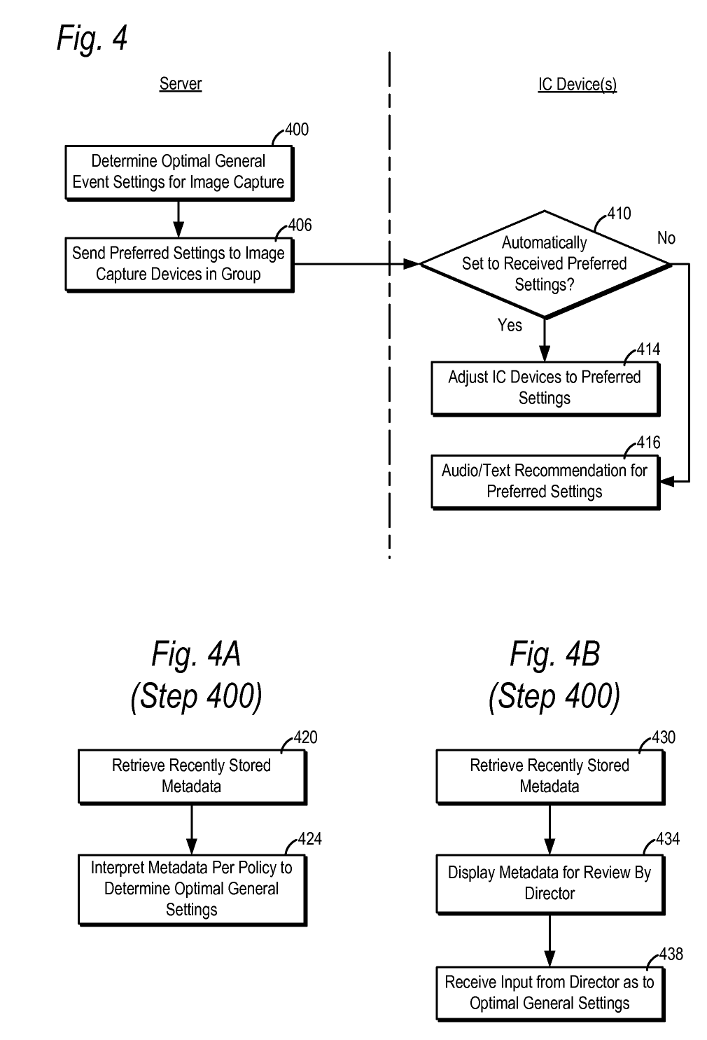

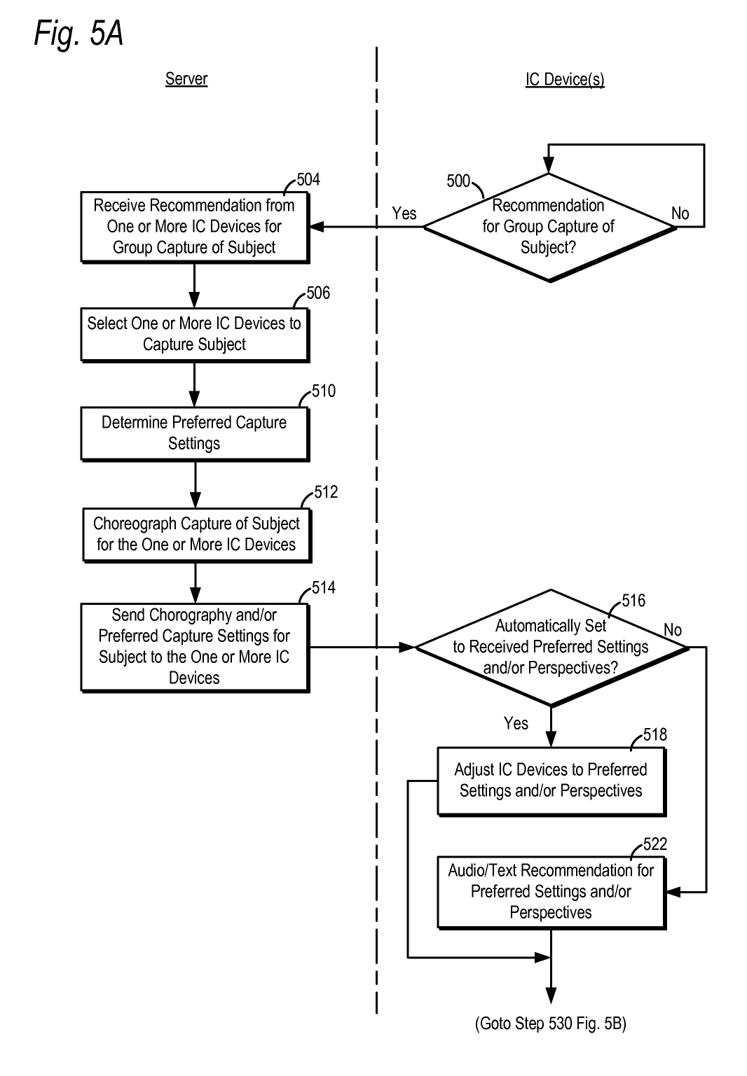

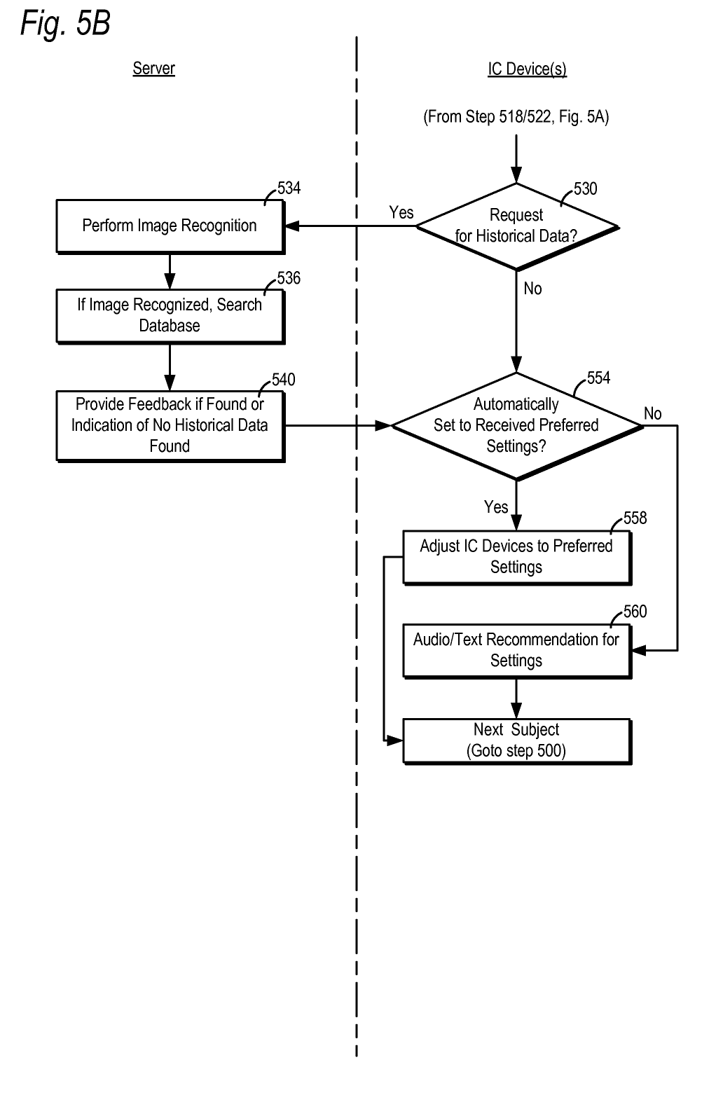

As explained above, metadata may be transmitted from the image capture devices 104 in an event capture group 110 to the server 106. The server 106 analyzes this metadata and in turn transmits feedback to the image capture devices 104 in an event capture group 110. This feedback may relate to coordinating the event capture group, or a portion of the group, to capture images of a particular subject at the event. This feature is explained below with reference to FIGS. 5A through 5B. However, even where there is no coordinated effort to capture a particular subject, the server 106 may still provide feedback on the best settings to use in capturing different images in general at the event. In this way, different images from different capture devices of different subjects at the event may still have similar appearance with respect to white balance, exposure, depth of field, etc. Thus, when these images are assimilated together into an image set as explained hereafter, the collection may have a consistent and cohesive appearance. Steps according to the present system for consistent capture of different subjects at an event in general will now be explained with reference to FIGS. 4 and 4A.

As indicated above, different image capture devices 104 in an event capture group 110 may continuously or periodically upload metadata relating to image capture device settings, the event and conditions at the event. In step 400, this metadata may be analyzed to determine optimal general settings for use by the image capture devices in the group 110 when capturing different subjects at the event. A variety of schemes may be used to analyze the metadata and make determinations about the optimal settings in step 400. Two such examples are set forth in FIGS. 4A and 4B.

In the embodiment of FIG. 4A, one or more policies may be input to the server 106 which direct how the server interprets the metadata to arrive at selections of optimal settings for the image capture devices. Those of skill in the art will appreciate a wide variety of criteria which can be used in such policies. In one embodiment, the policy may dictate that the server analyze the metadata from the various image capture devices 104 in the event capture group 110 to determine which settings are used by all or a majority of devices. For example, if the server 106 determines that all or a majority of devices are set to a particular F-stop setting, aperture speed, white balance setting, ISO sensitivity and/or that no flash is being used, then the server 106 may select these settings as the optimal settings. Alternatively or additionally, at least some of the settings may be set by the metadata relating to conditions at the event. In this embodiment, the policy may employ a stored lookup table which defines which settings are to be used for which event conditions; e.g., for measured sunlight in a given range, particular setting or group of settings indicated in the lookup table is used.

As indicated, a wide variety of other policies may be used which allow the server 106 to analyze the metadata received and, based on that metadata, make a recommendation regarding the optimal settings for the image capture devices. In the embodiment of FIG. 4A, the server 106 retrieves metadata from storage in step 420, and interprets the metadata per the stored policy or policies in step 424 to determine the optimal general settings for the image capture devices 104 in the group 110. It is further understood that the server 106 may have different policies it applies for different types of image capture devices (e.g., still image camera, video camera, cellular telephone, etc.).

In the above described sections, the optimal settings are determined by the server 106, based on an analysis of the metadata under one or more specified policies. However, in an alternative embodiment, the server may be omitted. In such an embodiment, the one or more policies may be stored on one or more of the image capture devices 104. In this case, the above-described steps may be performed by one or more of the image capture devices 104 in an event capture group 110 communicating directly with each other.

In a further embodiment of the present system, instead of the server applying a policy, a live person may act as a director, reviewing the metadata and/or images from the event and making decisions regarding the optimal settings to use based on his or her review. The director may use a wide variety of factors in making decisions based on the review of the metadata/images, including his or her knowledge, experience, aptitude, etc. Such an embodiment is shown in FIG. 4B. In step 430, the server 106 retrieves the metadata, and it is displayed to the director in step 434 over a display. Once the director has reviewed the metadata and has made decisions regarding the optimal settings, the director may input those settings to the server 106 in step 438 via an I/O device such as a keyboard and/or a pointing device such as a mouse.

In the embodiment described above, the director is physically located at the server 106, which may be remote from the event in embodiments. However, in an alternative embodiment, the director may instead be at the event. In such an embodiment, the server 106 may be at the event as well, for example as a laptop computer. Alternatively, the server 106 may still be remote from the event, and the director interacts with the server 106 via an image capture device or other computing device.

In an embodiment where the director is communicating with a server 106 via an image capture device, the director may have administrative or enhanced privileges with respect to how his or her image capture device interacts with the server. Thus for example, the director receives at his or her device all of the metadata collected by the other devices in the event capture group 110. Decisions made by the director are uploaded to the server for transmission back to other members of the event capture group.

In a still further embodiment where the director is a person at an event, the server 106 may be omitted. In such an embodiment, the image capture devices in a group 110 may communicate directly with the director's device, which may be an image capture device or other computing device with sufficient processing capabilities to handle the above-described operations.

Referring again to FIG. 4, after the metadata has been analyzed and decisions made as to optimal device settings for image capture devices at the event, these decisions may be sent to the image capture devices 104 in the group 110 in step 406. The recommendations may be sent to the group 110 as a whole, for example providing optimal settings for F-stop, aperture, shutter speed, ISO sensitivity, white balance and/or use of a flash. Alternatively, the recommendations may be sent to a subset of the group 110. For example, only those devices deviating from the optimal with respect to F-stop receive the recommendation; only those devices deviating from the optimal with respect to aperture receive the recommendation; only those devices deviating from the optimal with respect to shutter speed receive the recommendation; only those devices deviating from the optimal with respect to white balance receive the recommendation; only those devices deviating from the optimal with respect to ISO sensitivity receive the recommendation; only those devices deviating from the optimal with respect to use of a flash receive the recommendation; etc.

In embodiments, the client application may allow the device to automatically implement the optimal settings received from the server 106 in step 406. In step 410, the client application determines whether the image capture device is set to automatically implement the optimal settings received from the server. If so, the image capture device is adjusted to those settings in step 414.

On the other hand, a device 104 may not be set to automatically implement the optimal settings received from the server. In this case, the recommended settings may be conveyed to the user of the device 104 in step 416 audibly over the device speakers and/or visibly over the device LCD, both described above. The client application may translate the received data relating to optimal settings into real language for ease of understanding by a user of the image capture device. The user is then free to adopt one or more of the recommended settings or ignore them.

In the above-described examples, the image capture devices 104 in the event capture group 110 are able to send metadata and receive feedback in real time. However, as indicated above, it may happen that an image capture device is not able to wirelessly connect with the network and is not able to send metadata or receive feedback at the event. In this instance, the “offline” image capture device may connect to server 106 before the event to see if an event capture group was set up before the event (steps 300 through 310, FIG. 3). If so, the server 106 may be able to provide optimal settings to the offline device 104 (though based on estimated, pre-event metadata). The offline device may use those settings to capture images at the event and captured upload images when the device is next able to connect to the network 108. In this way, images from offline devices may still be integrated in a consistent and cohesive manner into an image set for the event.

It will be appreciated that general event recommendations may be created from metadata by steps other than or in addition to those set forth in FIGS. 4 through 4B. Moreover, it is understood that the steps described in FIGS. 4 through 4B may be carried out generally contemporaneously with the steps described above with respect to FIG. 3 (at least after an event capture group has been defined).

Specific Object Image Capture Feedback

As noted above, the present system can provide pre-capture coordination of specific subjects at an event. Steps for performing this coordination will now be described with reference to FIGS. 5A through 5B. In one embodiment, coordination of images for specific subjects may be performed using the steps for capturing subject images in general, as set forth above with respect to the flowcharts of FIGS. 4 through 4C. However, when capturing a specific subject, additional metadata may be used by the server 106 to coordinate the captured images. One such example is set forth below.

Initially, some mechanism directs the server 106 to focus image capture devices 104 from the event capture group 110 on a specific subject. This may be done in a variety of ways. In the example shown in FIG. 5A, one or more users of the image capture devices 104 may make a recommendation to the server in step 500 to invite other image capture devices to capture a specific subject. For example, a user can upload a text message or audio recording (assuming his/her device 104 has the capability) to join him/her in capturing a specific subject, which request is received at server 106 in step 504.

In an alternative embodiment, instead of a user sending a request, the server 106 can determine from the continuously or periodically uploaded metadata (step 318, FIG. 3) when two or more image capture devices are capturing the same subject. This may be done using GPS metadata indicating that a high concentration of image capture devices are in the same vicinity. It may also be done using orientation metadata indicating a concentration of image capture devices are pointed approximately at the same focal point. As indicated above, the position of image capture devices 104 may be determined by a GPS system, and sensors within the image capture devices can indicate the direction the devices are pointed at. Where a number of the image capture devices are pointed at approximately the same subject, the server 106 can determine this and recommend other devices in the event capture group 110 join in the capture of the specific subject.

A further alternative embodiment relates to an event where known and often photographed subjects are located (referred to below as “known subjects”). Known subjects may include monuments (e.g., the Space Needle in Seattle, Lincoln Memorial in Washington, D.C., etc.), subjects in parks and natural settings (e.g., Half Dome in Yosemite National Park), subjects at zoos and museums (e.g., the “Mona Lisa” in the Louvre), etc. For known subjects such as these and others, historical metadata may exist that is stored on server 106 or elsewhere. Thus, when the server detects that an image capture device 104 is proximate to one of these known and often photographed subjects, the server can direct one or more image capture devices to photograph/video the known subject. As explained below, the server may also have (or have access to) metadata on optimal positions and/or perspectives from where to capture these known subjects.

As indicated, the server 106 may be directed to provide feedback on a specific subject in a number of ways. Once the server 106 determines that there is a specific subject to capture, the server 106 can select one or more image capture devices 104 from the event capture group 110 in step 506 to capture the subject. The server 106 may simply direct all devices 104 in the group 110 to capture the subject. Alternatively, the server 106 can select a subset of the group to capture the subject. The subset may be all devices 104 within a given geographic area at the event. Alternatively, the subset can be all devices of a particular type (all still image cameras 104a), or a cross section of different devices (some still image cameras 104a and video cameras 104b). Other subsets are contemplated.

In step 510, the server 106 (or director) may determine the optimal image capture device settings for capturing the subject based on the recent metadata received. This determination may include at least the same steps as described above with respect to step 400, FIG. 4.

In addition to optimal settings, when capturing at least certain specific subjects, the server 106 (or director) in step 512 may also choreograph the positioning of the capture device(s) 104 selected to capture the subject, or choreograph a single device 104 to capture the subject from multiple positions. In certain instances, the server 106 may be able to determine the location of the subject. Where the subject is a known subject, the location of the subject is typically known and available via GPS. For a mobile subject (one that is not a known subject), the server 106 may at times still be able to determine the location of the subject based on finding a focal point of certain image capture devices around the subject. As indicated above, the position of image capture devices 104 may be determined by a GPS system, and sensors within the image capture devices can indicate the direction the devices are pointed at. This may enable the server 106 to determine the focal point and estimated position of the subject.

Where the position of a subject is known or identified, the server can choreograph the capture of the subject by ensuring the image capture devices 104 capture the subject from different positions and/or perspectives (step 512). If there are a disproportionately high number of image capture devices capturing the subject from one perspective, and much fewer or none from another perspective, the server can determine this in step 512 and relay this information to at least some of the image capture devices 104. Additionally, the server can receive metadata whether an image capture device 104, such as a still camera 104a, is oriented to capture landscape or portrait images. The server can provide feedback to one or more of the capture devices 104 to recommend landscape and/or portrait orientation for capturing a subject.

Moreover, where the subject is a known subject, there may be historical data regarding the optimal positions from which to capture the subject. For example, scores of people have photographed the Grand Canyon in Arizona. From these scores of photographs, information may be stored as to good or the best places from which to take photographs. This historical data can be stored within or accessible to server 106. Thus, using GPS and/or device orientation metadata relating to the position/orientation of one or more image capture devices, the server can direct users of the one or more image capture devices to reposition themselves to best capture the known subject. The server can also direct the image capture device to point in a specific direction indicated by the historical data to obtain an optimal perspective from which to capture the known object.

In the above steps relating to the server 106 determining optimal settings and choreographing image capture, it is understood that these steps may alternatively be performed by a human director, reviewing the metadata and making decisions based on the reviewed metadata as explained above. Moreover, as an alternative to the server 106 performing device setting determination and choreography, the server may be omitted, and these steps performed by one or more of the image capture devices 104 in an event capture group 110 communicating directly with each other.

In step 514, the determined recommended settings and/or choreography may be sent to the one or more capture devices 104 selected to capture the specific subject. The client application may allow the device to automatically implement the optimal settings and/or choreography instructions (such as tilting, panning and zooming the image capture device) received from the server 106. In step 516, the client application determines whether the image capture device is set to automatically implement the optimal settings and/or perspectives received from the server. If so, the image capture device is adjusted to those settings in step 518.

A device 104 may not be set to automatically implement the optimal settings/perspectives received from the server (or a device may need repositioning). In this case, the recommended settings and/or perspectives may be conveyed to the user of the device 104 in step 522 audibly over the device speakers and/or visibly over the device LCD, both described above. The client application may translate the received data relating to optimal settings and/or perspectives into real language for ease of understanding by a user of the image capture device. The user is then free to adopt one or more of the recommended settings and/or perspectives or ignore them.

It may happen that a user of an image capture device is at a known subject, and wishes to see if there is stored data relating to optimal perspectives from which to capture the subject (the image capture device may for example not have GPS capabilities and therefore, the server is unable to detect that the device 104 is at a known subject). In this instance, the user may enter a request for historical data in step 530 (FIG. 5B) via the image capture device. In one embodiment, the user may capture the known subject (either with a photograph or through the live view feature of his/her device), and the image then gets sent to the server. The server may perform an image recognition operation on the received image in step 534. Image recognition techniques are known in the art. One such image recognition technique is disclosed in U.S. Pat. No. 7,424,462, entitled, “Apparatus for and Method of Pattern Recognition and Image Analysis,” which patent is hereby incorporated by reference in its entirety.

If the image is recognized, the server 106 may search for and retrieve historical data relating to optimal capture perspectives in step 536. This search may be performed from the server's own memory, or the server can initiate a search of other databases to identify historical data relating to optimal capture perspectives.

In step 540, the server 106 provides feedback if the image was identified and historical data on the subject was found. This feedback may be optimal settings and/or perspectives for capturing the known subject, as described above in steps 510 and 512. The feedback may be automatically implemented or relayed to the user through his/her image capture device as shown in steps 554 through 560 and as described above. The system may then return to step 500 to await a next specific subject capture.

It will be appreciated that general subject capture recommendations may be created from metadata by steps other than or in addition to those set forth in FIGS. 5A and 5B. Moreover, it is understood that the steps described in FIGS. 5A and 5B may be carried out generally contemporaneously with the steps described above with respect to FIG. 3 (at least after an event capture group has been defined) and with respect to FIG. 4.

Image Upload and Organization

In addition to the pre-capture coordination of images as described above, the present system further relates to the uploading of captured images and the organization of the images from an event capture group 110 into a cohesive image set. The stored image set is organized by event and/or subcategories from the event and is accessible to members of the event capture group and possibly others. The captured images from all image capture devices 104 within a given event capture group 110 may be assimilated together into a single image set.

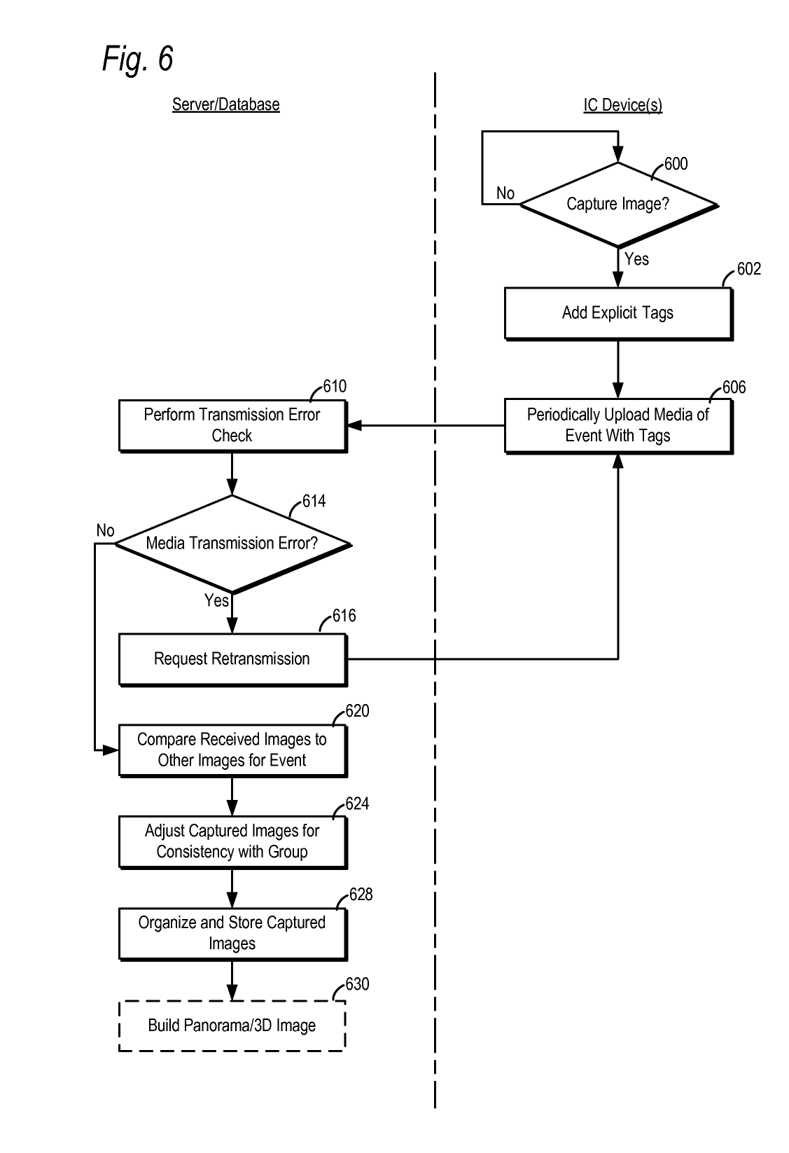

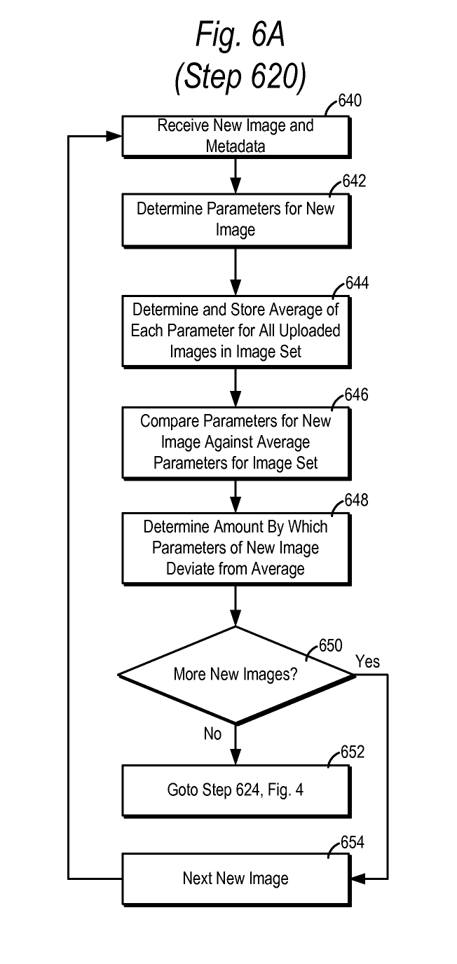

Referring now to step 600 in the flowchart of FIG. 6, this aspect of the system may begin with capture of an image. The image may be a photograph, video or other media captured in any of a variety of digital formats. Once an image is captured, the implicit metadata may be added in step 602 and stored for example in a sidecar file associated with the image file in the image capture device 104. The implicit metadata may include for example the event name, a caption or comment on the image, names of people in the image, keywords to allow query searching of time image and possibly a recommendation rating indicating a like/dislike of the captured image.

The implicit metadata may further include autotagging of people and objects appearing in the image. There are known software applications which may be loaded in system memory 260 of an image capture device which review images, identify faces and determine whether one or more people in an image can be identified. If so, the user may be asked to confirm the person's identity found by the application. If confirmed, the application may add that person's name as an autotag to the implicit metadata identified in step 602. Other metadata may be added in step 602 as well.

In step 606, the image files and metadata files may be uploaded. The uploaded metadata files include the implicit metadata added in step 602, as well as explicit metadata which is automatically associated by the capturing device with a captured image. The post-capture explicit metadata associated with an image may be the same as the pre-capture explicit metadata described above, but it may be different in further embodiments. The image and post-capture metadata (implicit and explicit) may be uploaded to database 112 through server 106. Alternatively, the image and metadata files may be uploaded to database 112 independently of server 106, for example where database 112 is not associated with server 106. The steps of FIG. 6 may be performed by a server associated with the database 112 (server 106 or other).

As is known, the system may perform a transmission error checking operation on the uploaded images and metadata in step 610. If errors in the transmitted image or metadata files are detected in step 614, retransmission of the data is requested in step 616. The error checking steps may be omitted in alternative embodiments.

If no transmission errors are detected (or the error checking steps are omitted), the present system may next compare the uploaded images to other captured and stored images from the same event capture group 110 in step 620. The purpose of steps 620 and 624 is to compare and adjust each newly uploaded image to the image set as a whole so that new images from the capture group match the appearance of the images already in the image set. Step 620 analyzes individual parameters of an image and compares them to the same parameters across the image set as a whole. These parameters may include color content, contrast, brightness and other image features.

Further details relating to the comparison step of 620 are shown in the flowchart of FIG. 6A. In step 640, a first of the newly uploaded images is obtained from memory. In step 642, the system analyzes the first received image to determine numerical values for the parameters of the new image. The system may also use the metadata associated with the new image in this analysis. The system may for example obtain parameter data relating to the color content, contrast, brightness and possibly other parameters of the image, each as a numerical value.

In step 644, the numerical parameter values across the entire image set (including the new image being considered) are averaged, and that average is stored. In step 646, for each parameter, the numerical parameter value for the new image is compared against the numerical average for that parameter in the image set, and the differences for the new image for each parameter are determined and stored in step 648. Step 650 checks whether there are additional new images. If so, the next image is obtained from memory and steps 642 through 650 are repeated. If all new uploaded images have been considered in step 650, the system moves to step 624 (FIG. 4).

In step 624, using the results of step 620, the measured parameters of each new image are adjusted to match the averages of those parameters across the image set. The color content of the new image(s) may be adjusted to match the average color content of images in the image set; the contrast of the new image(s) may be adjusted to match the average contrast of images in the image set; the brightness of the new image(s) may be adjusted to match the average brightness of images in the image set; etc. In this way, each new image may have its parameters adjusted to better match the appearance of the images in the image set as a whole. As discussed above, the pre-capture coordination of images already provides for enhanced matching of the images in the image set. As such, steps 620 and 624 may be omitted in further embodiments.

In step 628, the images may be organized and stored on database 112. The database server may include a login authorization so that only users having permission can gain access to a given image set. In an embodiment, all users of image capture devices 104 belonging to a given event capture group 110 would be given access to the image set from that event. Those users may then share the images with others and grant access to others as desired.

The database 112 in which the image sets are stored in step 628 may for example be a relational database, and the database may include a relational database management system. The images in the stored image set may be organized and accessed according to a variety of different schemas. The schemas may be indicated by at least some of the explicit and implicit metadata types. For example, users may access all images from an event, possibly in chronological order by the timestamp metadata. Or a user may choose to see images including only certain people by searching only those images including a given nametag. A user may choose to search by different locations at the event, using the GPS metadata and certain GPS recognized locations at the event. Or a user may search through the images using a given keyword.

In addition, the server 106 may receive a request pre-image capture to break an event into subcategories, which subcategories also get added as metadata for uploaded images. For example, an event may be broken down into an afternoon portion and an evening portion. By including this metadata with each captured image, images from one subcategory or another may be searched and accessed separately.

In embodiments described above, an image set is formed from images from members of a given event capture group. However, it is further contemplated that images may be added to an image set which were recorded by an image capture device that was not part of an event capture group. For example, an image capture device may have been offline at an event, but still captured images at the event which can be included in the stored image set for the event.

This may be done a number of ways. In one embodiment, a user may access the database where a given image set is stored, and manually add his or her images to the stored image set after. This may take place when the image capture device later connects to the network, or the images are copied to a computing device with a network connection. In another embodiment, a user may upload his or her images upon connecting to the network, and at that time, his or her images may be automatically added to a particular image set based on metadata associated with the images. In particular, the metadata may be examined by the processor associated with the database storing the images, and the processor may determine from one or more items of metadata that the images were captured from a particular event. The processor may for example look at the time and place the images were captured, an assigned event name, tagged identification of people or objects in the images, etc. Once the processor determines from the metadata that the uploaded images were from a particular event, the processor may add the images to the image set for the identified event.

In accordance with the present system, images from different devices at an event may be coordinated before images are captured. The images may further be adjusted into conformity with other images in the image set after they are uploaded to a storage site. This allows the different images from different devices at an event to be aggregated together into a single image set which has a cohesive and consistent appearance. Thus, users may view photos from the event, and form images into a personalized collection having a consistent appearance regardless of which device from the capture group made the image. Moreover, given the direct wireless connection with a remote server and database, images from different devices at the event may be assimilated into a single image set stored on the database even before the event has ended.

In a further embodiment, the present system enhances the ability of images to be built into panoramas and/or 3-dimensional views of an event, as shown in step 630 of FIG. 6. Steps for constructing panoramas and/or 3-dimensional views are known in the art. As the images have been coordinated both pre-capture and, possibly, post-capture, different images from different devices may be assimilated together into the panorama or 3-dimensional view and all images in the collection appear to be consistent with each other. Step 630 may be omitted in further embodiments.

The above described methods for pre-capture coordination of images may be described in the general context of computer executable instructions, such as program modules, being executed by a computer (which may be server 106, computer 116 or one or more of the image capture devices 104a through 104d). Generally, program modules include routines, programs, objects, components, data structures, etc., that perform particular tasks or implement particular abstract data types. The present system may also be practiced in distributed computing environments where tasks are performed by remote processing devices that are linked through a communications network. In a distributed computing environment, program modules may be located in both local and remote computer storage media including memory storage devices.

With reference to FIG. 7, a computing environment for implementing aspects of the present system includes a general purpose computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVDs) or other optical disk storage, magnetic cassettes, magnetic tapes, magnetic disk storage or other magnetic storage devices, or any other medium which can be used to store the desired information and which can be accessed by computer 710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 730 includes computer storage media in the form of volatile and/or nonvolatile memory such as ROM 731 and RAM 732. A basic input/output system (BIOS) 733, containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, DVDs, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7 provide storage of computer readable instructions, data structures, program modules and other data for the computer 710. In FIG. 7, for example, hard disk drive 741 is illustrated as storing operating system 744, application programs 745, other program modules 746, and program data 747. These components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer 710 through input devices such as a keyboard 762 and pointing device 761, commonly referred to as a mouse, trackball or touch pad. Other input devices (not shown) may include a microphone, joystick, game pad, satellite dish, scanner, or the like. These and other input devices are often connected to the processing unit 720 through a user input interface 760 that is coupled to the system bus 721, but may be connected by other interface and bus structures, such as a parallel port, game port or a universal serial bus (USB). A monitor 793, or other type of display device is also connected to the system bus 721 via an interface, such as a video interface 790. In addition to the monitor 793, computer 710 may also include other peripheral output devices such as speakers 797 and printer 795, which may be connected through an output peripheral interface 795.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communication over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed is:

1. A method of coordinating images from one or more image capture devices at an event for capturing images, the method comprising the steps of:
(a) receiving metadata from the one or more image capture devices relating to at least one of image capture device settings and event conditions;
(b) analyzing the metadata received in said step (a) to determine optimal image capture device settings for the one or more image capture devices at the event to use in capturing images;
(c) outputting feedback to the one or more image capture devices including the optimal image capture device settings determined in said step (b).

2. The method of claim 1, further comprising the step (d) of aggregating stored images captured at the event from the one or more image capture devices into a single image set that is available for viewing from a remote location before the event has concluded.

3. The method of claim 1, said step (a) of receiving metadata from the one or more image capture devices relating to at least one of image capture device settings and event conditions comprising the step of receiving explicit metadata determined by the one or more image capture devices including at least one of device settings, event time/date, event location, GPS location information relating to positions of the image capture devices, and identifiers for the image capture devices.

4. The method of claim 1, said step (a) of receiving metadata from the one or more image capture devices relating to at least one of image capture device settings and event conditions comprising the step of receiving implicit metadata added to the one or more image capture devices including at least one of a name for the event, identification of people or places in the image, comments on an image and one or more keywords for use in searching images.

5. The method of claim 1, said step (b) of analyzing the metadata comprising the step of a computing device applying a predetermined policy on how to interpret received metadata.

6. The method of claim 1, said step (b) of analyzing the metadata comprising the step of a human director receiving a display of the metadata, making decisions based on the metadata and inputting those decisions to a computing device for output to the image capture devices in said step (c).

7. The method of claim 1, said step (c) of outputting feedback to the one or more image capture devices comprising the step of outputting at least one of a recommended F-stop setting, shutter speed setting, white balance setting and ISO sensitivity setting to image capture devices at the event.

8. The method of claim 1, said step (c) of outputting feedback to the one or more image capture devices comprising the step of outputting at least one of a recommended position from which to best capture a subject, a recommended perspective from which to best capture a subject and whether to orient an image capture device for a landscape or portrait image.

9. The method of claim 1, wherein steps (a), (b) and (c) occur in real time while the image capture devices are at the event.

10. The method of claim 1, wherein steps (a), (b) and (c) are performed by a computing device remote from the event.

11. The method of claim 1, wherein steps (a), (b) and (c) are performed by a computing device at the event.

12. The method of claim 1, said step (c) of outputting feedback to the one or more image capture devices comprising the step of outputting feedback to a subgroup of less than all image capture devices sending metadata in said step (a) where the one or more image capture devices include a plurality of image capture devices.

13. A computer-readable medium having computer-executable instructions for programming a processor of an image capture device to perform a method of coordinating capture of images at an event, the method comprising the steps of:
(a) receiving admittance to a group of network-connected image capture devices;
(b) transmitting metadata relating to settings used on the image capture device;
(c) receiving an indication to use one or more settings on the image capture device in the capture of images at the event; and
(d) adjusting the image capture device to one or more of the one or more settings received in said step (c), said step (d) of adjusting being performed automatically or in response to setting changes made by a user of the image capture device.

14. The computer-readable medium of claim 13, the method further comprising the step (e) of transmitting images captured to a remote database while at the event.

15. The computer-readable medium of claim 13, said step (a) of receiving admittance to a group of network-connected image capture devices comprises at least one of the following steps:
(a1) receiving admittance based on a proximity of the image capture device to other image capture devices for at least a portion of a predetermined period of time; and
(a2) receiving admittance based on having a wireless network connection to other image capture devices.

16. The computer-readable medium of claim 13, said step (b) of transmitting metadata relating to settings used on the image capture device comprising the step of transmitting at least one of an F-stop setting, a shutter speed setting, a white balance setting, an ISO sensitivity setting, color calibration settings, color working space profile, an event time/date, event location, GPS location information relating to positions of the image capture devices, and an identifier for the image capture device.

17. A system for coordinating capture of images at an event, comprising:
an event capture group of two or more image capture devices at the event, the group defined dynamically upon wireless connection of the two or more devices to a network and membership in the event capture group capable of varying during the event;
a computing device with which the two or more image capture devices wirelessly communicate, the computing device controlling membership in the event capture group; and
a database for receiving and organizing images captured from different image capture devices in the event capture group into a single cohesive image set;
wherein image capture devices communicate metadata to the computing device relating to settings the image capture devices are using, and wherein the computing device communicates recommendations to image capture devices in the event capture set, the recommendations determined by the computing device based on analysis of the metadata received from the image capture devices.

18. The system of claim 17, the event capture group further defined by proximate location of the two or more image capture devices for at least a portion of a predetermined period of time.

19. The system of claim 17, wherein the computing device is a remote server.

20. The system of claim 17, wherein the database is a cloud storage website.
